(19) United States
(12) Patent Application Publication
(10) Pub. No.: US 2015/0028129 A1
(43) Pub. Date: Jan. 29, 2015

(54) BICONICAL EXHAUST CONE FOR A CIVIL AVIATION JET ENGINE

(71) Applicant: SNECMA, Paris (FR)

(72) Inventors: Pierrick MOUCHOUX, Paris (FR); Gaetan MABBOUX, Paris (FR); Eric DE VULPILLIERES, Paris (FR); Mathieu POISSON, Melun (FR); Jackie PROUTEAU, Villecresnes (FR)

(73) Assignee: SNECMA, Paris (FR)

(21) Appl. No.: 14/340,047

(22) Filed: Jul. 24, 2014

(30) Foreign Application Priority Data
Jul. 24, 2013 (FR) 13 57314

(51) Int. Cl. F02K 1/04

(52) U.S. Cl. CPC F02K 1/04
USPC 239/265.11

(57) ABSTRACT

A biconical exhaust cone for a civil aviation jet engine, this cone delimiting, on its outside, an annular exhaust stream of combustion gases and comprising an upstream frustoconical portion extending outward from upstream to downstream and a downstream frustoconical portion extending inward from upstream to downstream, wherein the downstream frustoconical portion comprises a segment which defines an outer annular surface of which one tangent, at any point along the longitudinal axis of the cone, is inclined by an angle greater than 40° and less than 90° with respect to this longitudinal axis.

### BACKGROUND OF THE INVENTION

The present invention relates to a biconical exhaust cone for a civil aviation jet engine.

### DESCRIPTION OF THE PRIOR ART

Conventionally, as shown in FIG. 1, a civil aviation jet engine, of the bypass type, permits a flow of gas to be accelerated from upstream to downstream in order to generate thrust. Traditionally, the flow of exhaust gases is conveyed to the outside in the downstream portion of the jet engine by means of an exhaust cone or plug which is mounted on the axis of the jet engine.

As shown in FIG. 1, an exhaust cone 3 takes the form of an envelope of circular cross section, the concavity of which faces upstream. The term upstream refers to the direction in which air flows in the jet engine. The exhaust cone 3 is of the biconical type and is specific to a civil aviation jet engine. The exhaust cone 3 is conventionally placed at the confluence of a primary flow F1 in a primary inner stream V1 and a secondary flow F2 in a secondary outer stream V2, the streams V1, V2 being separated by a separation wall at the downstream end of which is a mixer 2. The secondary flow F2 is delimited on the outside by a nacelle 1 of the jet engine.

The principal function of the exhaust cone consists in providing some of the pressure recovery which constitutes the thrust of the engine and in guiding the flow of the exhaust gases so as to avoid any separation. Indeed, such a separation affects the performance of the jet engine, which is a drawback.

In order to limit the risk of separation, it is known to provide an exhaust cone 3 of substantial axial length and of gentle slope (of the order of 25°), as shown in FIG. 1. Nonetheless, due to its length, such an exhaust cone 3 has considerable mass which adversely affects the efficiency of the jet engine. Moreover, the current trend is toward increased jet engine diameters, which amplifies the problem of the mass of the exhaust cone.

One of the aims of the invention is to propose an exhaust cone which is designed specifically for a civil aviation jet engine and whose mass is relatively low.

### SUMMARY OF THE INVENTION

The invention proposes a biconical exhaust cone for a civil aviation jet engine, this cone delimiting, on its outside, an annular exhaust stream of combustion gases and comprising an upstream frustoconical portion extending outward from upstream to downstream and a downstream frustoconical portion extending inward from upstream to downstream, wherein the downstream frustoconical portion comprises a segment which defines an outer annular surface of which one tangent, at any point along the longitudinal axis of the cone, is inclined by an angle greater than 40° and less than 90° with respect to this longitudinal axis, said segment having an upstream diameter at least equal to Dm/2 and a downstream diameter at most equal to Dm/8, Dm being the maximum diameter of the cone.

The present invention thus proposes a “short” exhaust cone or plug, that is to say an exhaust cone whose length has been reduced with respect to the prior art, this reduction in length having been brought about by modifying the slope defined by the outer surface of the cone. This slope is substantially greater than that of the prior art. In the prior art, this slope is generally less than 40° and may be equal to 90° when the cone is truncated, that is to say when its downstream end is formed by a flat wall perpendicular to the longitudinal axis of the cone.

Modal analysis has shown that the stiffener required on a long exhaust cone of the prior art, so as to place the diameter modes outside the operating ranges of the engine, may be omitted on a short exhaust cone according to the invention. Omitting this stiffener contributes to the mass saving. Moreover, the cone is thus easier to manufacture and its manufacturing cost is substantially reduced.

Although the cone according to the invention is referred to as biconical, its upstream and downstream portions are not perfectly conical or frustoconical but may have a general shape close to a cone or to a frustum. The term “biconical” thus refers to the general shape of the cone which comprises an upstream portion which is flared in the downstream direction and a downstream portion which is flared in the upstream direction.

The value of the angle of inclination of the aforementioned tangent preferably varies from one point to another along the longitudinal axis of the cone. The curvature of the cross section of the segment of the exhaust cone is thus non-zero at any given point, that is to say that this cross section has no straight portion.

The segment is preferably situated close to the downstream end of the cone.

The exhaust cone according to the invention is preferably of the non-truncated type. It may be formed in one piece.

The present invention also relates to a civil aviation jet engine, comprising an exhaust cone as described hereinabove. This jet engine may be of the bypass type. It preferably has no afterburner system. Afterburner systems are used only in military aviation jet engines. The jet engines of military airplanes have exhaust cones which are different to those of civil airplanes. They are in general not of the biconical type.

Furthermore, a civil aviation jet engine generally has a greater bypass ratio than a military aviation jet engine.

### DESCRIPTION OF THE DRAWINGS

The invention will be better understood and other details, features and advantages of the invention will emerge upon reading the following description, given as a non-limiting example and with reference to the appended drawings, in which:

FIG. 1 is a schematic representation of an axial section through a civil aviation bypass jet engine, an exhaust cone according to the prior art being represented by a broken line while an exhaust cone according to the invention is represented by a solid line;

FIG. 2 is a perspective representation from above of an exhaust cone according to the invention; and

FIG. 3 is a perspective representation from the side of the exhaust cone of FIG. 2.

### DESCRIPTION OF THE PREFERRED EMBODIMENT

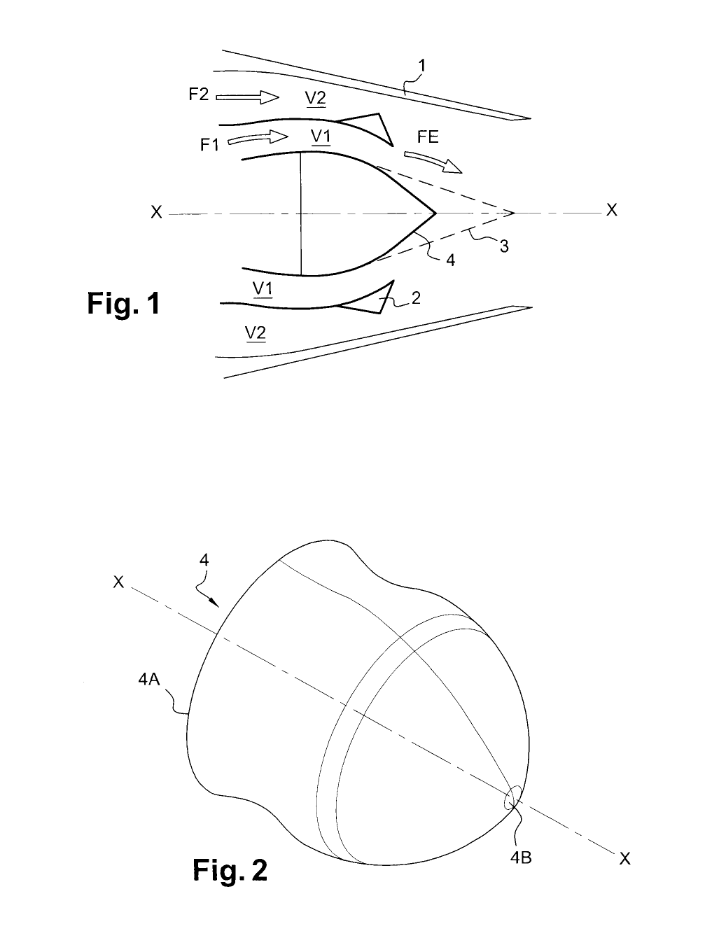

The invention relates to an exhaust cone 4 for a civil aviation jet engine, this cone 4 being of shorter length (in solid line in FIG. 1) in comparison with an exhaust cone 3 according to the prior art (in broken line in FIG. 1).

The exhaust cone 4 according to the invention will be presented for use in a jet engine in which air flows axially from upstream to downstream (from left to right in FIG. 1). The jet engine shown is of the bypass type and comprises a primary inner stream V1 and a secondary outer stream V2 within which flow, respectively, a primary flow F1 and a secondary flow F2. An exhaust cone 4 according to the invention is attached to the jet engine, on its X-axis, at the confluence of the primary flow F1 and the secondary flow F2 which form, after mixing, an exhaust flow FE. In this example, the exhaust cone 4 is mounted such that it is secured to an exhaust casing of the jet engine.

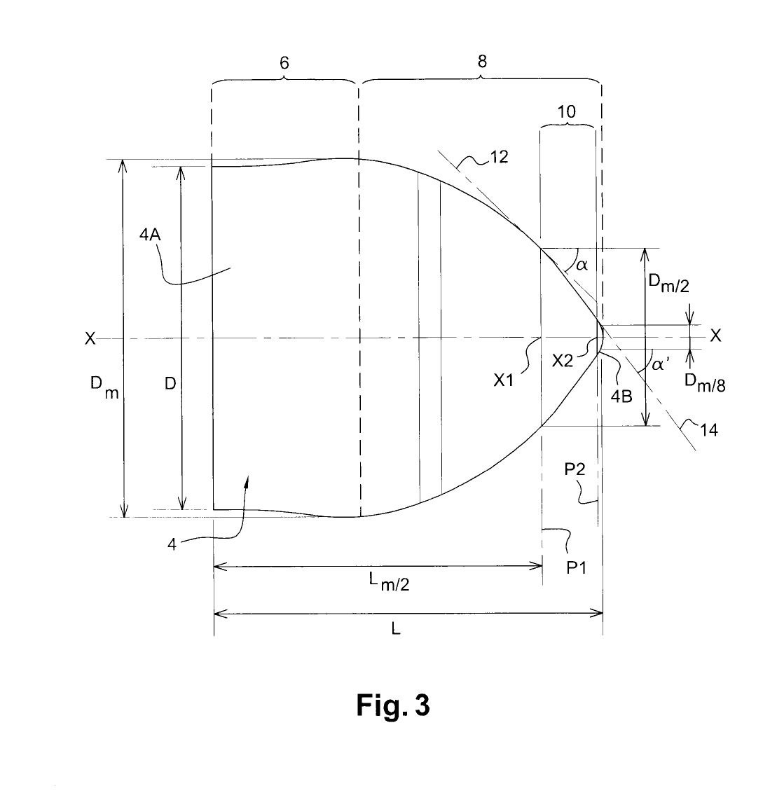

With reference to FIGS. 2 and 3, an exhaust cone 4 according to the invention is of the biconical type and comprises an upstream frustoconical portion 6 extending radially outward (with respect to the X-axis) from upstream to downstream and a downstream frustoconical portion 8 extending radially inward from upstream to downstream.

The exhaust cone 4 is preferably formed of a thin one-piece metal wall, for example of the order of 1 mm.

The cone 4 comprises an upstream end 4A designed to be attached to the jet engine and a point-shaped downstream end 4B. Consequently, the length L of the exhaust cone 4 is defined between its upstream end 4A and downstream end 4B.

The cone 4 has, in cross section in a first transverse reference plane P1, a diameter D_{m/2} equal to half the maximum diameter Dₘ of the cone, this maximum diameter corresponding to the diameter of the upstream end of its portion 8 or of the downstream end of its portion 6. The cone 4 has, in cross section in a second transverse reference plane P2, a diameter D_{m/8} equal to one eighth of the maximum diameter Dₘ of the cone.

The portion of the cone 4 which extends between the planes P1 and P2 defines an axial segment 10. According to the invention, the outer annular surface defined by this segment 10 has a steep slope. Reference number 12 designates a tangent at a point on this surface at axial position X1 along the X-axis and corresponding to the point at which an axial half-section of the cone 4 intersects with the plane P1, and reference number 14 designates a tangent at a point on the surface at axial position X2 and corresponding to the point at which an axial half-section of the cone 4 intersects with the plane P2. According to the invention, each angle α, α′ formed between a tangent 12, 14 and the X-axis, and between the tangent at any point Xi (axial position Xi), between points X1 and X2, is greater than 40° and less than 90°. In the example shown, each angle α, α′ is of the order of approximately 50°, and the angle α′ is greater than the angle α.

1. A biconical exhaust cone for a civil aviation jet engine, this cone delimiting, on its outside, an annular exhaust stream of combustion gases and comprising an upstream frustoconical portion extending outward from upstream to downstream and a downstream frustoconical portion extending inward from upstream to downstream, wherein the downstream frustoconical portion comprises a segment which defines an outer annular surface of which one tangent, at any point along the longitudinal axis of the cone, is inclined by an angle greater than 40° and less than 90° with respect to this longitudinal axis, said segment having an upstream diameter at least equal to Dm/2 and a downstream diameter at most equal to Dm/8, Dm being the maximum diameter of the cone.

2. The exhaust cone as claimed in claim 1, wherein the value of the angle of inclination of the aforementioned tangent varies from one point to another along the longitudinal axis of the cone.

3. The exhaust cone as claimed in claim 1, wherein the segment is situated close to the downstream end of the cone.

4. The exhaust cone as claimed in claim 1, which is of the non-truncated type.

5. The exhaust cone as claimed in claim 1, which is formed in one piece.

6. A civil aviation jet engine, comprising an exhaust cone as claimed in claim 1.

7. The jet engine as claimed in claim 6, which is of the bypass type.

8. The jet engine as claimed in claim 6, which has no afterburner system.
